(19) United States
(12) Patent Application Publication
(10) Pub. No.: US 2026/0050564 A1
(43) Pub. Date: Feb. 19, 2026

(54) ADAPTIVE INTERRUPT MANAGEMENT IN A DATA TRANSFORM ACCELERATOR

(71) Applicant: MaxLinear, Inc., Carlsbad, CA (US)

(72) Inventors: Pinaki Shankar Chanda, San Diego, CA (US); Michael Ray Ham, San Jose, CA (US)

(73) Assignee: MaxLinear, Inc., Carlsbad, CA (US)

(21) Appl. No.: 19/303,310

(22) Filed: Aug. 18, 2025

Related U.S. Application Data
(60) Provisional application No. 63/684,319, filed on Aug. 16, 2024.

(51) Int. Cl. G06F 13/24

(52) U.S. Cl. CPC G06F 13/24; G06F 2213/24

(57) ABSTRACT

A method may include identifying an application operable to submit one or more commands to a data transform accelerator. The method may also include determining one or more classes of service utilized with at least one bank of data transform engines in the data transform accelerator. The method may further include estimating a workload to be transmitted to the data transform accelerator. In response to the workload satisfying a threshold and interrupt control being enabled in the at least one bank of data transform engines, the method may also include configuring interrupt control for the one or more classes of service.

### CROSS REFERENCE TO RELATED APPLICATIONS

This U.S. Patent application claims priority to U.S. Provisional Patent Application No. 63/684,319, titled “ADAPTIVE INTERRUPT MANAGEMENT IN A DATA TRANSFORM ACCELERATOR,” and filed on Aug. 16, 2024, the disclosure of which is hereby incorporated by reference in its entirety.

### TECHNICAL FIELD

This disclosure generally relates to data transform acceleration, and more specifically, to adaptive interrupt management in a data transform accelerator.

### BACKGROUND

Unless otherwise indicated herein, the materials described herein are not prior art to the claims in the present application and are not admitted to be prior art by inclusion in this section.

Data transform accelerators are co-processor devices that are used to accelerate data transform operations for various applications such as data analytics applications, big data applications, storage applications, cryptographic applications, and networking applications. For example, a data transform accelerator can be configured as a storage accelerator and/or a cryptographic accelerator.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include identifying an application operable to submit one or more commands to a data transform accelerator. The method may also include determining one or more classes of service utilized with at least one bank of data transform engines in the data transform accelerator. The method may further include estimating a workload to be transmitted to the data transform accelerator. In response to the workload satisfying a threshold and interrupt control being enabled in the at least one bank of data transform engines, the method may also include configuring interrupt control for the one or more classes of service.

In another embodiment, a system may include a data transform accelerator and a host device. The data transform accelerator may include at least one bank of data transform engines. The host device may be in communication with the data transform accelerator. The host device may include an application that may be configured to submit one or more commands to the data transform accelerator. The application may also be configured to determine one or more classes of service utilized with the at least one bank of data transform engines. The application may further be configured to estimate a workload to be transmitted to the data transform accelerator. In response to the workload satisfying a threshold and interrupt control being enabled in the at least one bank of data transform engines, the application may also be configured to configure interrupt control for the one or more classes of service.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for adaptive interrupt management in a data transform accelerator;

FIG. 2 illustrates a flowchart for initializing interrupt rate control in a system;

FIG. 3 illustrates a flowchart for updating an interrupt throttle value in a system;

FIG. 4 illustrates a flowchart of an example method for adaptive interrupt management in a data transform accelerator; and

FIG. 5 illustrates an example computing device.

### DETAILED DESCRIPTION

A data transform accelerator may be used as a coprocessor device in conjunction with a host device or server (referred to as host device unless otherwise explicitly stated) to accelerate data transform operations for various applications, such as data analytics, big data, storage, and/or networking applications. The data transform operations may include, but not be limited to, compression, decompression, encryption, decryption, authentication tag generation, authentication, data deduplication, non-volatile memory express (NVMe) protection information (PI) generation, NVMe PI verification, and/or real-time verification. Such data transform accelerators may be connected to the host device using one or more various interface technologies, such as Peripheral Component Interconnect Express (PCIe), Universal Serial Bus (USB), Unified Configuration Interface (UCI), etc.

In some instances, interrupt load management may contribute to performance and/or efficiency of the system (e.g., the host device, the data transform accelerator, and the operations performed therein, as described). Frequent interrupts may cause frequent context switches and may reduce overall efficiency of the system. As such, the frequent interrupts may cause a bottleneck in submission of the commands and/or processing of the results from the data transform accelerator, which may slow down input/output (IO) throughput of processing the source data using the data transform accelerator. Efficient interrupt load management may help optimize CPU usage, efficiently process resources, improve IO throughput, and/or reduce power consumption. Interrupt load management may help in scaling out multiple data transform accelerators where more than one data transform accelerator may be attached to the host device. Interrupt load management may facilitate the system being able to scale to handle an increased demand that may be present when working with multiple data transform accelerators without degradation of performance in the system.

The present disclosure proposes a system and method to adaptively change a rate of interrupts from the data transform accelerator, based on the data submitted in the commands, bottleneck in the IO throughput, and/or pending commands in the containers. The present disclosure may be applicable for any data transform accelerator and/or any data processing device implemented in an embedded processor, application-specific integrated circuit (ASIC), field-programmable gate array (FPGA), and/or software-hardware integration, attached to the host device, where interrupts may be used to signal a completion of data processing operations submitted to the data transform accelerator, and/or any other coupled device.

The present disclosure proposes a method to control an interrupt rate that may be configurable for each class of service that may be supported in the data transform accelerator. Alternatively, or additionally, the interrupt rate may be configurable for each class of service support in each bank of data transform engines in the data transform accelerator. As such, the interrupt rate may be configured by applications running on the host device that may be rate controlled for submission of commands, or the rate may be limited by the data transform accelerator device (e.g., not done explicitly by the application on the host device). The present disclosure may be applicable when the data transform application may be run on host operating system of the host computer or in virtualized environment where the application may be run on one or more virtual machines on the host computer, each submitting commands to one or more data transform accelerators.

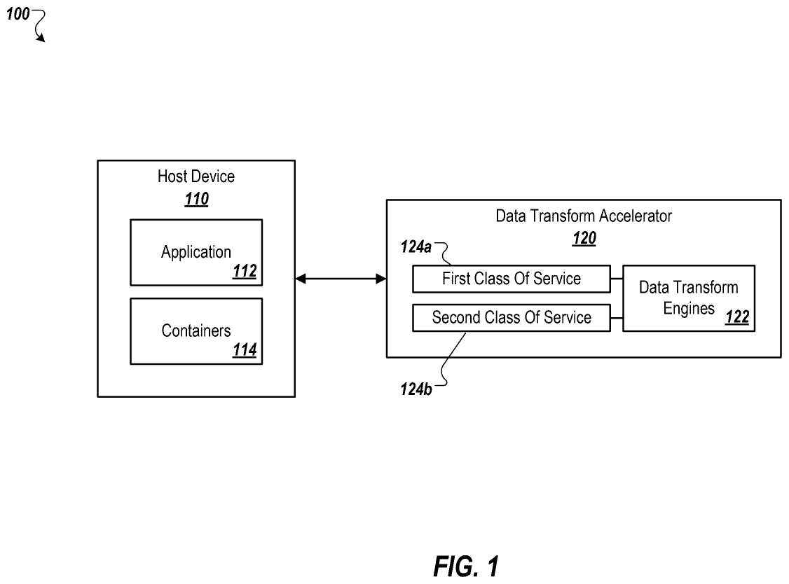

FIG. 1 illustrates a block diagram of an example system 100 for adaptive interrupt management in a data transform accelerator. The system 100 may include a host device 110, and a data transform accelerator 120. The host device 110 may be include an application 112 and containers 114. The data transform accelerator 120 may include data transform engines 122, a first class of service 124a, and a second class of service 124b, referred to collectively as classes of service 124.

The host device 110 may be a computer, server, and/or other computing device that may be in communication with the data transform accelerator 120. In some instances, the host device 110 may utilize a data communication interface (e.g., a Peripheral Component Interconnect express (PCIe) interface, a Universal Serial Bus (USB) interface, and/or other similar data communication interfaces) to communicate with the data transform accelerator 120.

In some instances, the data transform accelerator 120 may include the data transform engines 122 as compute resources. Algorithm accelerations may be provided by the data transform engines 122. Algorithm accelerations could be data transform operations such as compression, decompression, encryption, decryption, authentication tag generation and verification, data deduplication, NVMe protection information generation and verification, and/or real-time verification. The data transform engines 122 may be operable to perform operations in a parallel manner.

The data transform engines 122 can be connected in a pipeline in the data transform accelerator 120. In some instances, there may be more than one pipeline that may be configured to operate in parallel with other pipelines. The pipelines in the data transform accelerator 120 could be in an encode direction and/or in a decode direction. In some instances, there can be more than one bank of transform engines 122 in the data transform accelerator 120. For example, a first bank of data transform engines 122 may be for both encode operations and decode operations and a second bank of data transform engines 122 may be for only decode operations.

The host device 110 may submit commands to the data transform accelerator 120, as well as source data to be transformed and/or addresses of output buffers configured to hold the transformed data. The host device 110 may also provide control information and/or metadata that describes specific algorithmic transformation to be applied on the source data. A command may include of a set of source data descriptors and a set of destination data descriptors. The input data buffers may be described by the source data descriptors and the output buffers may be described by the destination data descriptors. At least some of the source buffer descriptors may point to one or more input data buffers that may contain metadata and/or control information that may describe the transformation algorithms and/or how the source data may be transformed. A set of containers 114 may be created in memory of the host device 110 (as illustrated) and/or on on-chip memory of the data transform accelerator 120 (not illustrated) to hold the addresses of the commands.

In some instances, the data transform accelerator 120 may be configured to support the classes of service 124 for processing the source data. The multiple classes of service 124 may be in view of different service level agreements, such as in terms of data transform throughput and/or latency associated with the transform operations. For each of the classes of service 124, a set of the containers 114 may be designated to submit commands to the data transform accelerator 120 corresponding to the classes of service 124.

Based on the metadata, the data transform engines 122 may perform operations on the source data. Once the operations are complete, the transformed data may be returned to the host device 110 via the output buffers. On completion of the operation, the data transform accelerator 120 may signal the CPU in the host device 110 by using an interrupt for the command.

In some instances, interrupt rate control may apply to the interrupts that may be raised on completion of commands by the data transform accelerator 120. Alternatively, or additionally, interrupt rate control may not be applied on the interrupts that may be used to notify of an error and/or for communications between the host device 110 and the data transform accelerator 120.

Interrupt rate control may be performed by changing an interrupt throttle value for each of the containers 114 from which the commands may be submitted. The interrupt throttle value may refer to a setting of the data transform accelerator 120 that may control the rate at which interrupts are signaled to the CPU in the host device 110. In some instances, the interrupt throttle value may be specified as a unit of time. For example, setting the interrupt throttle value to 10 us in at least one of the containers 114 may indicate after processing one interrupt from the container, a next interrupt may be raised after at least 10 us of time. Changing the interrupt throttle value may facilitate a frequency in which interrupts may be handled. Alternatively, or additionally, a different interrupt throttle value may be used that may not be specified in time (e.g., a rate of interrupt). In some instances, the data transform accelerator 120 may be operable to provide a hardware register for each of the containers 114 that may be accessible by the host device 110. Alternatively, or additionally, the application 112 on the host device 110 may be operable to write a particular interrupt throttle value in the hardware register.

In some instances, the interrupt rate control may be configured (e.g., enabled or disabled) individually for each of the classes of service 124 in each bank of the data transform engines 122 by the application 112 in the host device 110. In instances in which the interrupt rate control may be disabled for a particular bank of the data transform engines 122, the containers 114 belonging to the classes of service 124 in the particular bank of data transform engines 122 may not use interrupt rate control. In instances in which interrupt control may be enabled for a particular bank of the data transform engines 122, an additional configuration for the classes of service 124 in the particular bank of the data transform engines 122 may be performed. Each of the classes of service 124 may have a unique configuration to enable and/or disable interrupt rate control independent of the other classes of service 124. In instances in which interrupt rate control is enabled for a class of service, the interrupt rate control for the containers 114 in the class of service may be enabled. Otherwise, the interrupt rate control for the containers 114 in the class of service may be disabled. Such configuration can be set during an initialization of the application 112 controlling the data transform accelerator 120. Alternatively, or additionally, the configuration, as described, may be performed dynamically.

Interrupt rate control can be applied when the application 112 may be used in an operating system in the host device 110 or in a guest operating system running virtually, such as a virtual machine on the host device 110. In virtualization, a physical function driver of the data transform accelerator 120 may configure interrupt rate control for the containers 114 from different classes of service 124 exported to each virtual machine. In instances in which there may be no notion of class of service in the virtual environment, each of the containers 114 exported to the virtual machines may be configured independently for interrupt rate control.

Configuration of the interrupt rate control may be set for each of the containers 114 during initialization of the containers 114, which can happen during driver load or dynamically when data transform operations may be in progress. For virtualization, the configuration of the interrupt rate control may be done in the physical function (PF) driver initialization, or later, such as dynamically when data transform operations may be in progress by commands submitted from application 112 running in the virtual machine. The application 112 running on the virtual function (VF) driver in guest operating system can make a dynamic request to PF driver by using a communication interface between the PF driver and the VF driver through the data transform accelerator 120.

In instances in which a configuration of the interrupt rate control is enabled, the interrupt rate control may be useful particularly for short data frame size submitted for processing to the data transform accelerator 120. Above a threshold (e.g., Sthreshold), the interrupt rate control may not be used for the container associated with a particular class of service.

Short data frames may generate frequent interrupts, which may contribute to a need for controlling rate at which interrupts may be handled. A typical workload for the data transform accelerator 120 may include a mix of commands with various source data and/or destination data that may be generated from transform operations on the source data.

An average data frame size may be estimated independently for each bank of data transform engines 122 and for each of the classes of service 124 using the following methods for each. In some instances, it may not be necessary to estimate the average data frame size for each command submitted to the data transform accelerator 120.

For encode commands, the following may be performed for each of the classes of service 124. For every time period (T_{s_estimate}), which may be determined empirically, an average size of the ingress workload may be estimated based on the source data frame size:
Estimated data frame size (Sₑₛₜ)=α*Sₑₛₜ+(1−a)*source data frame size

For decode commands, the following may be performed for each of the classes of service 124. For every time period (T_{s_estimate}), which may be determined empirically, an average size of the egress workload may be estimated based on the output data frame size:
Estimated data frame size (Sₑₛₜ)=β*Sₑₛₜ+(1−B)*output data frame size

The coefficients in the above formulas for estimation (e.g., a and B) may be determined based on experimentation with the workload. In some instances, storage devices may have a limited number of command sizes (other than end of file resultant odd block sizes) and the command sizes may be determined from the source size and/or the destination buffer size, as the platform may know the decoded size. In instances in which the data frame size is below the threshold (e.g., Sthreshold, which may be determined empirically), the interrupt rate control may be invoked in the containers 114 where a class of service definition may be configured to enable interrupt rate control. This may be done independently for the banks of data transform engines 122 for each of the classes of service 124.

In some instances, there may be different applications of the data transform accelerator 120. A first set of applications may not be rate controlled and/or may try to submit as many commands as possible until the throughput may be limited by: 1) the data transform accelerator 120 (e.g., a number of transform operations per second), 2) the interface to the data transform accelerator 120 (e.g., a number of lanes and/or a speed of the PCIe interface), and/or 3) software and/or hardware resources in the SDK and the host device 110 (memory, number of CPUs, memory bandwidth, CPU clock frequency). A second set of applications can be rate controlled (e.g. a number of data transform commands per seconds and/or rate of input data submitted per second). In instances in which the second set of applications may be implemented, the achieved throughput may or may not be limited by the throughput provided by data transform accelerator 120, the application 112 of the host device 110, and/or the host device 110.

In instances in which the throughput achieved by the data transform accelerator 120 and the application 112 may be substantially the same as (or limited by) the throughput offered by the data transform accelerator 120 and/or by the interface width and speed for each of the classes of service 124 (e.g., as determined by characteristics associated with the data transform accelerator 120), interrupt rate control may not be enabled. In some instances, reducing CPU utilization while maintaining the same throughput and without degradation of the latency of the submitted commands may be a reason to implement interrupt rate control, when interrupt rate control may otherwise not be implemented.

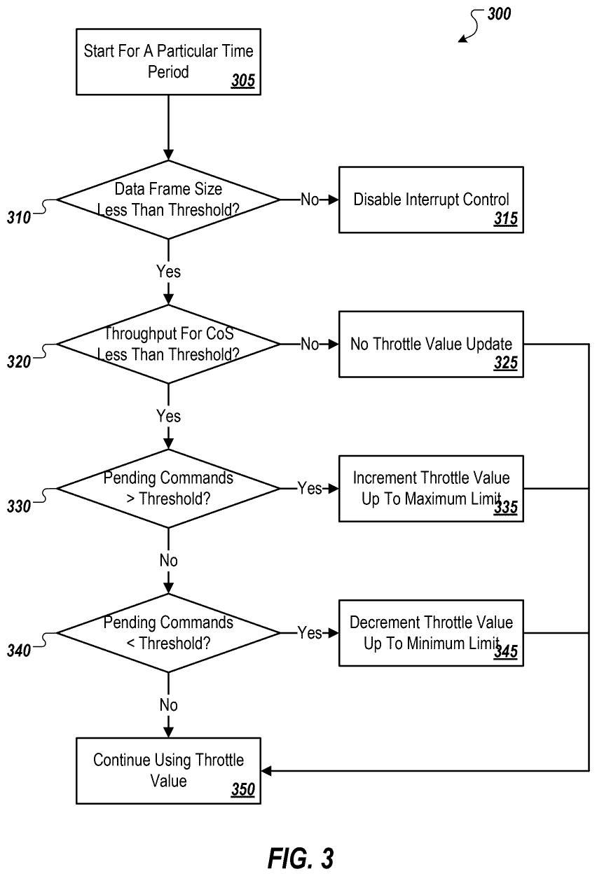

If the throughput achieved by the data transform accelerator 120 and the application 112 may be the same as (or limited by) the submission rate of the commands from a rate-controlled application, interrupt rate control may not be enabled. In some instances, reducing CPU utilization while maintaining the same throughput and without degradation of the latency of the submitted commands substantially may be a reason to implement interrupt rate control, when interrupt rate control may otherwise not be implemented. This can be determined by observing the number of the pending commands in the containers 114 of the data transform accelerator 120, as described by the flowchart 300 of FIG. 3

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

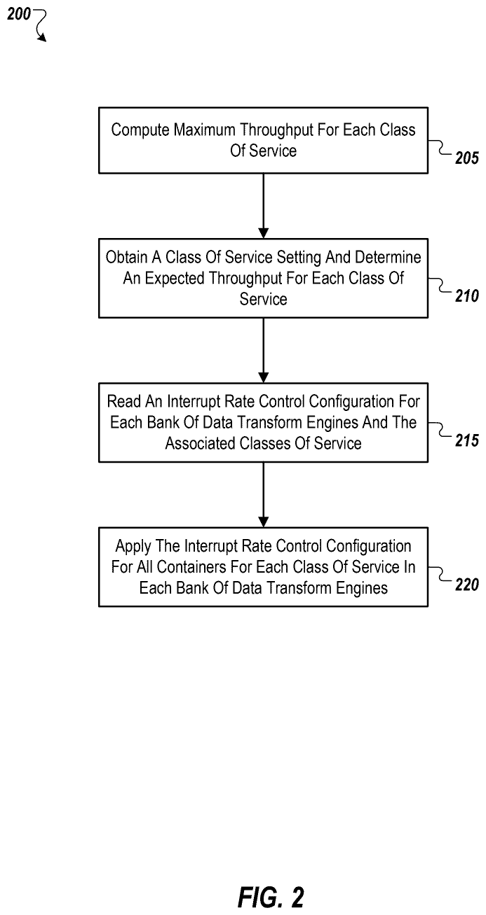

FIG. 2 illustrates a flow 200 for initializing interrupt rate control in a system, such as the system 100 of FIG. 1. The flow 200 may begin at block 205 where a maximum throughput may be computed for each class of service included in a data transform accelerator and/or associated with one or more banks of data transform engines in the data transform accelerator. In some instances, the maximum throughput for each class of service may be based on characteristics of the data transform accelerator (e.g., different data transform accelerators may have different maximum throughput capabilities), and/or the maximum throughput may be scaled by a PCIe interface rate.

At block 210, a class of service setting may be obtained (e.g., from an XML file or other data source). An expected throughput may be determined for each class of service based on the configuration of the classes of service for the class of service setting implemented.

At block 215, an interrupt rate control configuration may be read and/or applied to each bank of the data transform engines. Alternatively, or additionally, the interrupt rate control configuration may be applied to each class of service associated with each bank of the data transform engines.

At block 220, the interrupt rate control configuration may be applied for each container associated with each class of service in each of the banks of the data transform engines.

Modifications, additions, or omissions may be made to the flow 200 without departing from the scope of the present disclosure. For example, the designations of different elements in the manner described is meant to help explain concepts described herein and is not limiting. Further, the flow 200 may include any number of other elements or may be implemented within other systems or contexts than those described. For example, any of the components of FIG. 2 may be divided into additional or combined into fewer components.

FIG. 3 illustrates a flowchart 300 for updating an interrupt throttle value in a system, such as the system 100 of FIG. 1. At block 305, a sampling of data frame sizes, throughput, and/or pending commands may be performed over a particular period of time. Sampling the number of commands in the containers may be done periodically, such as at every Tn interval where n may be the number of pending commands at any sampling instance.

At block 310, an average data frame size may be compared to a threshold. In instances in which interrupt rate control is enabled for a container and data frames submitted to the container are greater than a threshold value, interrupt rate control may be activated, and the flow may proceed to block 320. Alternatively, or additionally, in instances in which an average data frame size submitted to the container are less than a threshold value, interrupt rate control may be disabled, as illustrated in block 315. Interrupt rate control may be controlled by the number of pending commands in the containers.

At block 320, a throughput for each class of service associated with each bank of data transform engines may be determined. In instances in which the determined throughput may not be less than a threshold and when interrupt rate control may be enabled, there may not be an adjustment to the throttle value, as illustrated in block 325. In such instances, the flow may proceed to block 350, where the throttle value (e.g., the unchanged throttle value) may continue to be used. In instances in which the determined throughput may be less than a threshold, the flow may proceed to block 330.

At block 330 and block 340, an estimation of the pending commands may be obtained. Estimation of the pending commands in a container may be performed by using an estimation process that may compute an average number of commands in a sliding window. Estimating the value on the epochs of command submission or retrieval can bias the estimation process. The estimated number of pending commands may be determined using the following:
Estimated number of pending commands (ηₑₛₜ)=α*ηₑₛₜ+(1−a)*n

Alternatively, or additionally, a different estimation methodology may be used to determine an average number pending commands. Initially, each of the containers may be assigned an initial interrupt throttle value, tᵢ. A hysteresis loop may be used to control the interrupt throttle value tᵢ, as described relative to the flowchart 300. In interrupt rate control, pending command hysteresis may be defined by a minimum and maximum number of estimated pending commands value, where the interrupt throttle may be increased and decreased respectively. Based on the estimated average number of commands in the containers, the interrupt throttle value tᵢ of the containers may be programmed.

In instances in which the estimated number of pending commands may be greater than a threshold, the flow may proceed to block 335. If the estimated average number of commands in the containers 114 is greater than a threshold (ηₕ), the interrupt throttle value may be increased by a fixed value Δtᵢ compared to the last applied value, as shown:

tᵢ=tᵢ+Δtᵢ

In instances in which the estimated number of pending commands may be less than a threshold, the flow may proceed to block 345. If the estimated average number of commands in the container is less than the threshold ηₕ, the interrupt throttle value may be decreased by a fixed value Δtᵢ compared to the last applied value:

tᵢ=tᵢ−Δtᵢ

Following the incrementing or decrementing as described in blocks 335 and 345, respectively, the flow may proceed to block 350 where the updated throttle value (e.g., the incremented throttle value or the decremented throttle value) may be used.

Modifications, additions, or omissions may be made to the flowchart 300 without departing from the scope of the present disclosure. For example, the designations of different elements in the manner described is meant to help explain concepts described herein and is not limiting. Further, the flowchart 300 may include any number of other elements or may be implemented within other systems or contexts than those described. For example, any of the components of FIG. 3 may be divided into additional or combined into fewer components.

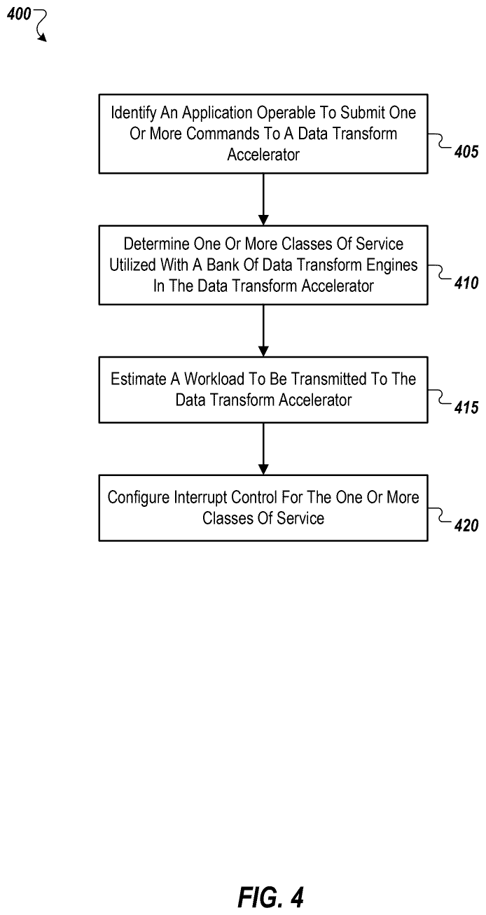

FIG. 4 illustrates a flowchart of an example method 400 for adaptive interrupt management in a data transform accelerator. The method 400 may be performed by processing logic that may include hardware (circuitry, dedicated logic, etc.), software (such as is run on a general purpose computer system or a dedicated machine), or a combination of both, which processing logic may be included in any computer system or device such as the host device 110 and/or the data transform accelerator 120 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method may begin at block 405 where an application operable to submit one or more commands to a data transform accelerator may be identified. In some instances, the application may run on a host device. Alternatively, or additionally, the application may run on a virtual machine on the host device.

At block 410, one or more classes of service utilized with at least one bank of data transform engines in the data transform accelerator may be determined. In instances in which interrupt control is disabled for the at least one bank of data transform engines, the interrupt control for the one or more classes of service utilized with the at least one bank of data transform engines may be disabled. In some instances, the interrupt control may be enabled for a first class of service of the one or more classes of service and the interrupt control may be disabled for a second class of service of the one or more classes of service.

At block 415, a workload to be transmitted to the data transform accelerator may be estimated. In some instances, the workload associated with an encode command may be estimated using a source data frame size. Alternatively, or additionally, the workload associated with a decode command may be estimated using an output data frame size. Alternatively, or additionally, the workload may be estimated using a source buffer size and/or a destination buffer size.

At block 420, interrupt control for the one or more classes of service may be configured. The interrupt control may be configured in response to the workload satisfying a threshold and/or interrupt control being enabled in the at least one bank of data transform engines.

Modifications, additions, or omissions may be made to the method 400 without departing from the scope of the present disclosure. For example, in instances in which the interrupt control is enabled, the workload may be periodically sampled to estimate an average number of the commands included therein. Alternatively, or additionally, a throttle value associated with the interrupt control may be adjusted, in response to the average number of the commands satisfying a threshold. In some instances, the throttle value may be incremented by a fixed value when the average number of the commands may be greater than an upper threshold. Alternatively, or additionally, the throttle value may be decremented by a fixed value when the average number of the commands may be less than a lower threshold.

In another example, the designations of different elements in the manner described is meant to help explain concepts described herein and is not limiting. Further, the method 400 may include any number of other elements or may be implemented within other systems or contexts than those described.

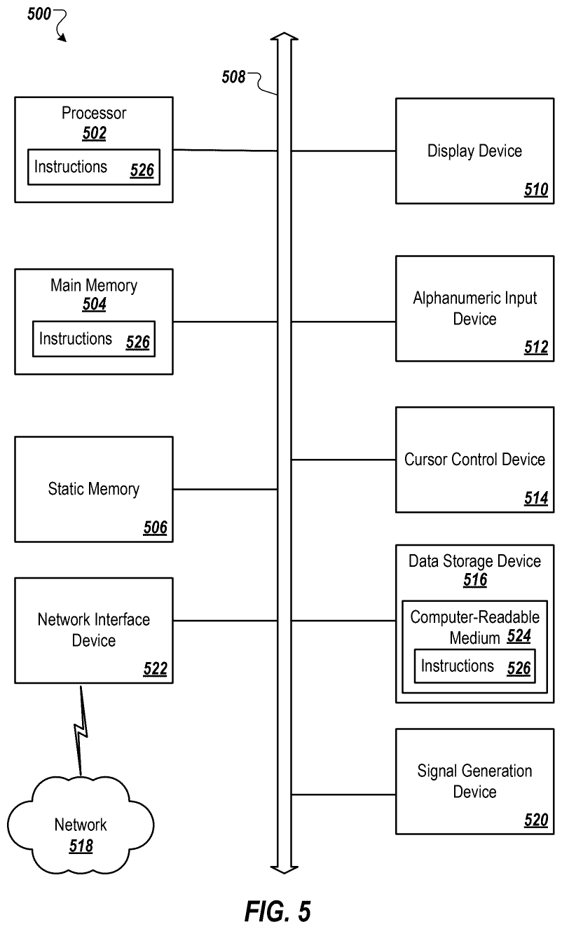

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. A method, comprising:
identifying an application operable to submit one or more commands to a data transform accelerator;
determining one or more classes of service utilized with at least one bank of data transform engines in the data transform accelerator;
estimating a workload to be transmitted to the data transform accelerator; and
in response to the workload satisfying a threshold and interrupt control being enabled in the at least one bank of data transform engines, configuring interrupt control for the one or more classes of service.

2. The method of claim 1, wherein in response to the interrupt control being enabled, further comprising:
periodically sampling the workload to estimate an average number of the commands included therein; and
in response to the average number of the commands satisfying a threshold, adjusting a throttle value associated with the interrupt control.

3. The method of claim 2, wherein the throttle value is incremented by a fixed value when the average number of the commands is greater than an upper threshold.

4. The method of claim 2, wherein the throttle value is decremented by a fixed value when the average number of the commands is less than a lower threshold.

5. The method of claim 1, wherein the application runs on a host device.

6. The method of claim 5, wherein the application runs on a virtual machine on the host device.

7. The method of claim 1, wherein in response to the interrupt control being disabled for the at least one bank of data transform engines, disabling the interrupt control for the one or more classes of service utilized with the at least one bank of data transform engines.

8. The method of claim 1, wherein the interrupt control is enabled for a first class of service of the one or more classes of service and the interrupt control is disabled for a second class of service of the one or more classes of service.

9. The method of claim 1, wherein the workload associated with an encode command is estimated using a source data frame size.

10. The method of claim 1, wherein the workload associated with a decode command is estimated using an output data frame size.

11. The method of claim 1, wherein the workload is estimated using a source buffer size or a destination buffer size.

12. A system, comprising:
a data transform accelerator comprising at least one bank of data transform engines; and
a host device, in communication with the data transform accelerator, comprising an application, the application configured to:
submit one or more commands to the data transform accelerator;
determine one or more classes of service utilized with the at least one bank of data transform engines;
estimate a workload to be transmitted to the data transform accelerator; and
in response to the workload satisfying a threshold and interrupt control being enabled in the at least one bank of data transform engines, configure interrupt control for the one or more classes of service.

13. The system of claim 12, wherein in response to the interrupt control being enabled, the application is further configured to:
periodically sample the workload to estimate an average number of the commands included therein; and
in response to the average number of the commands satisfying a threshold, adjust a throttle value associated with the interrupt control.

14. The system of claim 13, wherein the throttle value is incremented by a fixed value when the average number of the commands is greater than an upper threshold.

15. The system of claim 13, wherein the throttle value is decremented by a fixed value when the average number of the commands is less than a lower threshold.

16. The system of claim 12, wherein the application runs on a virtual machine on the host device.

17. The system of claim 12, wherein in response to the interrupt control being disabled for the at least one bank of data transform engines, disabling the interrupt control for the one or more classes of service utilized with the at least one bank of data transform engines.

18. The system of claim 12, wherein the interrupt control is enabled for a first class of service of the one or more classes of service and the interrupt control is disabled for a second class of service of the one or more classes of service.

19. The system of claim 12, wherein:
the workload associated with an encode command is estimated using a source data frame size; and
the workload associated with a decode command is estimated using an output data frame size.

20. The system of claim 12, wherein the workload is estimated using a source buffer size or a destination buffer size.
